(19) United States
(12) Patent Application Publication
(10) Pub. No.: US 2025/0128327 A1
(43) Pub. Date: Apr. 24, 2025

(54) VIBRATING MECHANISM FOR CONTROLLING POWDER DISPENSING IN ADDITIVE MANUFACTURING SYSTEMS, AND RELATED SYSTEMS AND METHODS

(71) Applicant: Blue Origin LLC, Kent, WA (US)

(72) Inventors: Steven James Craigen, Auburn, WA (US); Ramiro Cecchet, Seattle, WA (US); Michael J. Panzarella, Seattle, WA (US); Brian Barnes, Burien, WA (US)

(21) Appl. No.: 18/490,610

(22) Filed: Oct. 19, 2023

(51) Int. Cl. B22F 10/37; B22F 10/85; B22F 12/67; B33Y 10/00; B33Y 30/00; B33Y 50/02

(52) U.S. Cl. CPC B22F 10/37; B22F 10/85; B22F 12/67; B33Y 10/00; B33Y 30/00; B33Y 50/02

(57) ABSTRACT

Additive manufacturing systems and associated methods are disclosed herein. In some embodiments, the additive manufacturing system includes a build chamber that has an active build region, a support platform positioned in the active build region and movable in an upward direction, and a recoater arm positioned in the build chamber and movable in a first lateral direction above the active build region. The recoater arm can spread a powder over the active build region during a build process using first and second blades. The recoater arm can also include at least one orifice component positioned between the first and second blades to block a flow of the powder while the at least one orifice component is stationary and a vibrational component operably coupled to the at least one orifice component. The additive manufacturing system can also include a controller operably coupled to the vibrational component, to control operation of the vibrational component.

### TECHNICAL FIELD

The present technology is directed generally to systems and methods for additive manufacturing, including systems and methods for controlling powder deposition in an additive manufacturing system.

### BACKGROUND

Additive manufacturing, also commonly referred to as 3D printing, includes depositing layers of material to create a three-dimensional object. These techniques have found a wide variety of applications and can be used to produce objects of nearly any shape, based on data from a three-dimensional, computer-generated model.

In a typical powder bed additive manufacturing process, a thin layer of powder is spread over a build surface. A laser or other energy beam follows a computer-generated path over the powder to melt and solidify the powder only in areas corresponding to a planned build object on any given layer. Then an additional layer of powder is laid upon the first layer, and the laser again solidifies the target portions of powder. Successively sintering the powder layers melts and joins layers together to build up the planned build object. Accordingly, this process is repeated until the complete object is manufactured.

For each layer of the build, the process deposits a volume of powder, then spreads the powder by passing a recoater arm over the build surface and/or previous layers. The volume of the powder provided for each individual layer is typically more than is necessary to coat the surface to the desired depth, so as to avoid shortfills, but not so much as to have excess powder building up. Shortfills result in errors in the build object, such as gaps due to missing powder, warpage as sintered powder flows into the gaps, and the like. Excess powder can also result in errors in the build object, for example by disrupting (e.g., blocking or partially blocking) the recoater arm while spreading the next layer. As a result, it is desirable to direct the excess powder away from the build surface, such as into an overflow bin and/or a disposal system.

After the object is manufactured, the unused powder on the build surface (e.g., around, but not a part of, the build object) is removed, and the finished build object is separated from the support substrate. While the foregoing process is suitable for producing a wide variety of objects, there remains a need for improving the accuracy with which the powder is deposited for each layer.

### BRIEF DESCRIPTION OF THE DRAWINGS

FIG. 1A is a partially schematic, partially cross-sectional view of an additive manufacturing system configured in accordance with some embodiments of the present technology.

FIG. 1B is a partially schematic side view of a recoater arm configured in accordance with some embodiments of the present technology.

FIG. 2 is an isometric view of a portion of a powder deposition system configured in accordance with some embodiments of the present technology.

FIG. 3 is a top view of a recoater arm having a powder deposition system configured in accordance with some embodiments of the present technology.

FIG. 4 is a partially schematic side view of a recoater arm configured in accordance with further embodiments of the present technology.

FIG. 5A is a partially schematic, partially cross-sectional view of an additive manufacturing system configured in accordance with further embodiments of the present technology.

FIG. 5B is a partially schematic side view of a recoater arm configured in accordance with further embodiments of the present technology.

FIG. 6 is a flow diagram of a process for operating an additive manufacturing system in accordance with some embodiments of the present technology.

The drawings have not necessarily been drawn to scale. Similarly, some components and/or operations can be separated into different blocks or combined into a single block for the purpose of discussion of some of the implementations of the present technology. Moreover, while the technology is amenable to various modifications and alternative forms, specific implementations are shown by way of example in the drawings and are described in detail below. The intention, however, is not to limit the technology to the particular implementations described.

### DETAILED DESCRIPTION

### Overview

Additive manufacturing systems, and associated methods, are disclosed herein. The additive manufacturing systems can include a build chamber that includes an active build region, a support platform positioned in the active build region and movable in a travel direction with upward and downward components, a recoater arm movable in a first lateral direction above the active build region to spread a powder over the active build region during a build process, and a controller operably coupled to various components of the additive manufacturing system.

The recoater arm can include one or more blades extending in a second lateral direction at an angle to the first lateral direction, and a powder deposition system positioned to deposit a volume of powder to be spread in a new layer by the blade(s). For example, the recoater arm can include a first blade and a second blade spaced apart from the first blade. In this example, the powder deposition system can include at least one orifice component positioned between the first and second blades and a vibrational component operably coupled to the orifice component. The orifice component includes a plurality of openings that are sized to at least partially inhibit and/or impede a flow of powder through the orifice component (e.g., from a powder storage area or powder source to a spreadable position) while the orifice component is stationary. Put another way, the at least one orifice component can have a first mode in which no powder or a first amount of powder passes through the openings, and a second mode in which a second amount of powder passes through the openings, with the second amount being non-zero and greater than the first amount. The orifice component can be positioned such that an individual powder element (e.g., a single particle) passes through only a single opening, in a single orifice component, to move through the recoater arm to the spreadable position (e.g., to be deposited). The vibrational component can vibrate the orifice component to establish a pathway for the powder through the orifice component.

In some embodiments, the recoater arm includes multiple orifice components in a single layer or plane. In such embodiments, for example, the powder can pass through a first orifice component, a second orifice component, etc. to move along the pathway through the recoater arm to the spreadable position. Still, in such embodiments, the powder moves through only one of the orifice components along the pathway. Said another way, the orifice components can be positioned such that they do not overlap (or do not overlap such that one orifice component inhibits the flow of the powder while another is vibrating). In some embodiments, the recoater arm includes only a single orifice component.

Further, the controller can be operably coupled to the vibrational component to operate the vibrational component, so as to dispense and/or deposit a volume of the powder based on a target volume for the new layer during the build process. In some embodiments, the controller can use one or more operating parameters to control the volume of the powder dispensed. For example, the volume of the powder dispensed can be proportional to the speed of the vibrational component during operation and the controller can set, adjust, and/or otherwise control the speed of the vibrational component. In another example, the volume of the powder dispensed can be proportional to the length of time the vibrational component is operated and the controller can set, adjust, and/or otherwise control that length of time (sometimes also referred to herein as the operation period and/or the like). In yet another example, the location to which the powder is dispensed can be varied during a build (e.g., dispensed all in the peripheral portion before the recoater arm moves, while the recoater arm is moving over the central portion, and the like).

In some embodiments, the controller can update the target volume and/or the operational parameters throughout the build. For example, the target volume can be updated based on feedback from one or more sensors in the additive manufacturing system (e.g., signals indicating a previous layer had an insufficient volume of powder to spread evenly, signals indicating a previous layer had an excess volume of powder, and/or the like).

The use of one or more orifice components that are each positioned such that a powder element moves through only a single orifice to move through the recoater arm (e.g., in a single layer or plane), as opposed to multiple components through which powder must flow, can help increase the controller's ability to control the volume of the powder that is deposited. For example, the single layer reduces the number of variables that impact the volume of the powder and/or reduces the number of moving components that can clog (and/or otherwise degrade from normal wear and tear) and impact the volume of the powder that is deposited. These benefits can be especially realized in embodiments having a single orifice component. Additionally, or alternatively, the single layer reduces the number of moving components requiring regular maintenance to address normal wear and tear. As a result, the single layer can reduce the operating costs of the additive manufacturing system. These benefits can also be especially realized in embodiments having a single orifice component. Additionally, or alternatively, the combination of the single layer and the vibrational component can require less operating space that powder depositing systems with additional components. By using less space, the combination of the single layer and the vibrational component can provide more space for an onboard powder storage component and/or reduce the amount of space required for the recoater arm.

In some embodiments, the additive manufacturing system further includes a powder storage component (or other suitable powder source) operably coupled to the recoater arm upstream from the orifice component. In some embodiments, the recoater arm includes an onboard powder storage component positioned upstream from the orifice component.

In some embodiments, the vibrational component includes an eccentric cam that is operably coupled to the orifice component. Rotating the eccentric cam can cause the orifice component to vibrate and/or oscillate, thereby creating the pathway for the powder through the orifice component. In various embodiments, the eccentric cam can be drivable via movement of a fluid (e.g., an inert gas or other suitable fluid) through the eccentric cam, an electric motor, and/or any other suitable drive mechanism.

In some embodiments, the powder deposition system includes multiple vibrational components operably coupled to the orifice component. For example, the powder deposition system can include a first vibrational component operably coupled to a first end region of the orifice component and a second vibrational component operably coupled to a second end region of the orifice component. This can be useful when the orifice component itself absorbs a portion of the vibrational energy imparted by a single vibrational component to ensure that a pathway is created for the powder across the entire orifice component. Further, in some embodiments, the orifice component has a width extending at least as wide as a width of the active build region to deposit new powder across the entire width of the active build region. The dispersed deposition can reduce the number of trips over the active build region that the recoater arm must take to spread an even (or generally even) new layer of the powder.

For ease of reference, the additive manufacturing systems, and components thereof, are sometimes described herein with reference to top and bottom, upper and lower, upwards and downwards, and/or horizontal plane, x-y plane, vertical, or z-direction relative to the spatial orientation of the embodiments shown in the figures. It is to be understood, however, that various components of the additive manufacturing systems can be moved to, and/or used in, different spatial orientations without changing the overall structure and/or function of the disclosed embodiments of the present technology. Additionally, the additive manufacturing systems, and components thereof, are sometimes described herein with reference to proximate and distal and/or the like. It is to be understood, absent an explicit description otherwise, that these terms are relative to the structures and/or pathways being discussed. For example, powder distribution channels and/or components thereof are sometimes discussed as proximate to the blades, and the proximate positioning is relative to the movement of powder in the additive manufacturing system.

### DESCRIPTION OF THE FIGURES

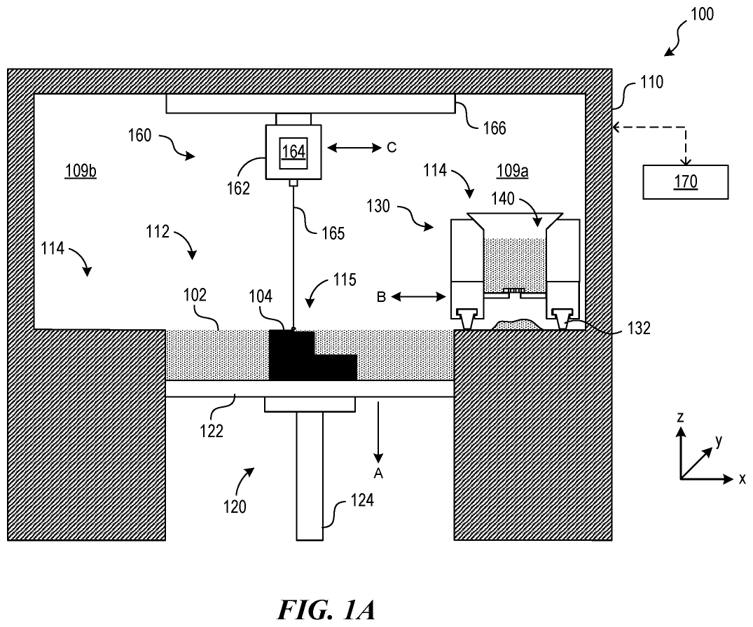

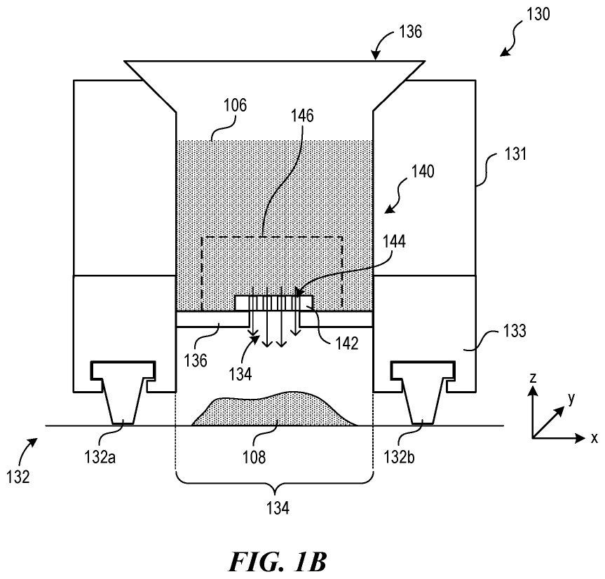

FIG. 1A is a partially schematic, partially cross-sectional view of an additive manufacturing system 100 configured in accordance with some embodiments of the present technology. As illustrated, the additive manufacturing system 100 (“system 100”) can include a build chamber 110 (shown in cross-section). The build chamber 110 includes a central portion 112 and a peripheral portion 114 positioned laterally outwardly from to at least a portion of the central portion 112. The system 100 also includes a support system 120, a recoater arm 130, and an energy beam system 160, each positioned within the build chamber 110.

In the illustrated embodiment, the support system 120 includes a support platform 122 and a first actuator 124 operably coupled to the support platform 122. The support platform 122 (e.g., a plate or other suitable support structure, sometimes also referred to herein as a “build platform”) extends across at least a portion of (or all of) the central portion 112, thereby defining an active build region 115 in the build chamber 110. The first actuator 124 is operably coupled to the support platform 122 to move the support platform 122 in an upward and downward direction along a first motion path A (e.g., along a z-axis). The recoater arm 130, discussed in more detail below, includes one or more blades 132 (two shown in the illustrated embodiment) and a powder deposition system 140 (sometimes also referred to herein as a “powder dispensing component,” an “onboard powder storage component,” and/or a “powder source”).

During an additive manufacturing process (sometimes referred to herein as a “build process” and/or a build”), the first actuator 124 can move the support platform 122 downward to make room for a new layer of a powder 102 to be deposited over the active build region 115. The powder can include a metallic powder, such as titanium-based powders, steel-based powders, stainless steel-based powders, aluminum-based powders, copper-based powders, nickel-based powders, and the like; various suitable ceramic powders; glass composites; and/or any other suitable material. After the support platform 122 moves downward, the powder deposition system 140 can deposit a volume of new powder. Next, the recoater arm 130 can move in a lateral direction along a second motion path B (e.g., along the x-axis) over the support platform 122 from a first position 109a to a second position 109b. In some embodiments, the first and second positions 109a, 109b are on opposite sides of the build chamber 110 (e.g., moving from the peripheral portion 114 on the right of the central portion 112 to the peripheral portion 114 on the left of the central portion). As the recoater arm 130 moves, the blade(s) 132 spread the volume of the powder 102 in a thin, generally uniform layer over the active build region 115.

In some embodiments, spreading the new layer requires a trip forward and backward along the second motion path B (e.g., forward from the first position 109a (e.g., the illustrated position) to the second position 109b, then backward from the second position 109b to the first position 109a). In various embodiments, the system 100 can include a powder recycling system and/or a powder disposal system in the peripheral portion 114 to help manage excess powder at either end of the second motion path B. Purely by way of example, the system 100 can include a powder recycling system of the type disclosed in U.S. Patent Application No. [Attorney Docket No. 034563.8052.US00]_by Steve Craigen filed concurrently herewith, the entirety of which is incorporated herein by reference.

In some embodiments, the first actuator 124 moves the support platform 122 downward between the forward and backward motions of the recoater arm 130. In such embodiments, for example, the forward motion from the first position 109a to the second position 109b can spread a first portion of a powder layer, while the backward motion from the second position 109b to the first position 109a can spread the second portion of the powder layer. In other embodiments, the support platform 122 does not move between the forward and backward motion. In such embodiments, both motions can help to spread the entire powder layer over the active build region 115.

After the powder layer has been fully deposited and spread over the active build region 115, the energy beam system 160 can sinter the powder 102 in a controlled pattern to form a build object 104. In the illustrated embodiment, the energy beam system 160 includes an energy beam head 162 carrying one or more energy beam sources 164 (one is shown in FIG. 1A) and a track 166. The energy beam source(s) 164 directs one or more energy beams 165 toward the active build region 115 to sinter the powder 102 in the newly deposited layer onto the build object 104. In the illustrated embodiment, the track 166 allows the energy beam head 162 to move in a lateral direction along a third motion path C. The track 166 itself can move along a y-axis (transverse to the plane of FIG. 1A and perpendicular to the z and x-axes) to cover the active build region 115. In turn, the energy beam head 162 can use the movement to target appropriate regions of the active build region 115. Additionally, or alternatively, the energy beam head 162 can include one or more reflectors operably coupled to one or more servo motors to direct the energy beam(s) 165 toward the active build region 115.

After the energy beam system 160 sinters the powder 102 in the active build region 115, the build process can repeat the steps above to move the support platform 122 downward, spread a new layer of the powder 102 over the active build region 115, and sinter the new layer. These steps can be repeated any number of times until the build object 104 is complete. After the build object 104 is completed, a user can remove the build object 104, any unused powder (e.g., non-sintered powder) can be recovered, and the first actuator 124 can move the support platform 122 upward to reset the support system 120 for the next build.

As further illustrated in FIG. 1A, the system 100 can include a controller 170 (shown schematically) programmed with instructions for directing the operations and motions carried out by the support system 120, the recoater arm 130, the powder deposition system 140, the powder recycling system, the energy beam system 160, and/or any other suitable components of the system 100. Accordingly, the controller 170 can include a processor, memory, and input/output devices, any of which can include a computer-readable medium containing instructions for operating the system 100. The instructions can be executed by the controller 170 to perform some or all of the tasks described herein. In some embodiments, the controller 170 is configured to receive a computer-generated model of the build object 104 and to control the operations and motions of the components of the system 100 to manufacture the build object 104 based on the computer-generated model. In some embodiments, the controller 170 is configured to receive feedback information about the additive manufacturing process from, for example, various sensors, cameras, and the like that can be located within the chamber 110. The controller 170 can also be configured to modify/direct operations and motions of the various components of the system 100 based at least in part on the received feedback information.

For example, information from sensors can indicate that the powder deposition system 140 is depositing an insufficient amount of the powder 102 to fully cover the central portion 112. Insufficient coverage can result in a shortfill in a future powder layer if the insufficiency is not addressed. In this example, the controller 170 can be configured to receive the information and control the powder deposition system 140 to deposit larger volumes of powder in the following layers, thereby avoiding a future shortfill. In another example, the sensors can indicate that the powder deposition system 140 is depositing an excessive amount of powder that is causing excess powder to build up in the build chamber 110 (e.g., in the peripheral portion 114, between the blades 132 of the recoater arm 130, and/or the like). In this example, the controller 170 can be configured to receive the information and control the powder deposition system 140 to deposit smaller volumes of powder in the following layers, thereby reducing (or eliminating) negative effects of excess build-up. By detecting insufficient and excessive volumes of the powder 102, the controller 170 can improve the quality of the build object 104 resulting from the build process. For example, the actions of the controller 170 can prevent gaps and/or warpages in the build object 104 caused by a shortfill resulting from insufficient depositions.

FIG. 1B is a partially schematic side view of a recoater arm 130 of the type illustrated in FIG. 1A configured in accordance with some embodiments of the present technology. As illustrated in FIG. 1B, the recoater arm 130 can include a housing 131 to which the blades and the powder deposition system 140 are coupled. In the illustrated embodiment, the recoater arm 130 includes two blades 132 (referred to individually as first and second blades 132a, 132b) spaced apart on either side of an opening 134 in the housing 131. Each of the blades 132 is coupled to the housing 131 via a track 133. In some embodiments, the tracks 133 fixedly attach the blades 132 to the housing 131 (e.g., such that the blades 132 cannot move with respect to the housing 131). In other embodiments, the tracks 133 allow the blades 132 to move in a lateral direction with respect to the housing 131 (e.g., along the y-axis transverse to the illustrated view). In such embodiments, the movement can allow the blades 132 to be refreshed during the build process (e.g., new sections of the blades 132 can be moved into position to spread the powder over the active build region 115 of FIG. 1A). The refresh process can help address normal wear and tear on the blades 132 during the build process (e.g., wear from the build object while spreading a new layer of powder over the build object). In various embodiments, the blades 132 can extend across a part of the central portion 112 of FIG. 1A (e.g., have an effective edge with a length in the y-direction (e.g., into and out of the page) that is less than a width of the central portion 112 in the y-direction), extend fully across the central portion 112, and/or extend beyond the central portion 112.

The powder deposition system 140 can be coupled to (or integrated with) the housing 131 in the opening 134 to deposit powder 106 for a new layer between the first and second blades 132a, 132b (e.g., in a spreadable location). This position allows the powder deposition system 140 to deposit a volume of spreadable powder 108 between trips over the active build region 115 (FIG. 1A). In various other embodiments, however, the powder deposition system 140 can be attached to the housing 131 in various other locations (e.g., partially within the housing 131, on a sidewall with an output valve directed between the first and second blades 132a, 132b, and/or any other suitable position).

In the embodiment illustrated in FIG. 1B, the housing 131 further includes edge portions 136 defining a perimeter of the opening 134. The powder deposition system 140 includes at least one orifice component 142 (one is shown in the illustrated embodiment, e.g., a plate or other suitable component) positioned over the edge portions 136 and has one or more openings 144 therein. The powder deposition system 140 also includes a vibrational component 146 (sometimes also referred to herein as an “oscillating component”) operably coupled to the at least one orifice component 142 (“orifice component 142”). The vibrational component 146 vibrates, oscillates, or otherwise moves the orifice component 142 in a controlled, multi-directional manner. These motions are referred to collectively herein as “vibrations.” The openings 144 (sometimes also referred to herein as “perforations,” “passages,” “through-holes,” and/or the like) in the orifice component 142 are sized and/or positioned to (1) at least partially prevent the powder 106 from moving through the orifice component 142 when the orifice component 142 is static (or almost static) and (2) allow the powder 106 to move through the orifice component 142 when the orifice component 142 is vibrating. Said another way, the openings 144 are sized and/or positioned to at least partially inhibit powder flow through the orifice component 142 (i.e., such that none of the powder 106, or not enough of the powder 106 to impact the build process, flows through the orifice component 142 unless the orifice component 142 is vibrating. Said yet another way, operating the vibrational component 146 causes a volume of the powder 106 to move through the orifice component 142 in a controlled manner. Furthermore, the orifice component(s) 142 are positioned such that a powder element (e.g., a single particle of the powder 102) only moves through a single orifice component between a stored position (e.g., the powder 106 within the recoater arm 130) and a spreadable position (e.g., the spreadable powder 108). Said another way, the orifice component(s) 142 include only a single orifice component 142 or are positioned such that a first orifice component does not inhibit (and/or impede) the flow of the powder 106 through a second orifice component (e.g., positioned in a single layer or plane, in non-overlapping layers, and the like).

Further, the volume of the spreadable powder 108 deposited can be correlated with various operational parameters, such as the amount of time the vibrational component 146 is operated, the vibration frequency, the speed of the vibrational component 146, the magnitude of the vibrations, a number of cycles the vibrational component 146 is operated for, where the vibrational component 146 is coupled to the orifice component 142, how many vibrational components 146 are operated (e.g., only one, or one on both sides of the orifice component 142), and/or the like. Each of the operational parameters can be set, changed, and/or otherwise controlled by the controller 170 of FIG. 1A. Purely by way of example, the controller 170 can set the operational parameters at the start of a build process and the vibrational component 146 can operate according to the operational parameters after each pass over the active build region 115 (FIG. 1A). When no insufficient and/or excessive volumes are detected, the operational parameters can remain the same throughout the build process. However, if/when an insufficient and/or excessive volume is detected, the controller 170 (FIG. 1A) can update the operational parameters to adjust the volume of the spreadable powder 108 deposited in a given pass to account for the detected insufficient and/or excessive volume.

Additionally, or alternatively, the controller 170 (FIG. 1A) can update the operational parameters throughout a build to account for a build plan for the build object and/or changing characteristics of the powder. For example, new powder can flow through the orifice component 142 more easily than powder that has been recycled one or more times. This may be because new powder particulates tend to be rounder, while recycled particulates have non-round (e.g., oblong) shapes. In this example, the controller 170 can adjust the operating parameters to account for the relative age of the powder and/or the flowing properties. Additionally, or alternatively, a size of the particles in the powder can be dependent on the type of powder being used (e.g., varying particle sizes for different metals and/or other suitable build materials). In this example, the controller 170 can adjust the operating parameters to account for the relative size of particle being used. In a specific, non-limiting example, the the controller 170 can increase the vibrational speed and/or duration for powder that has been recycled. In another example, the controller 170 can adjust the operating parameters to deposit less powder overall and/or spread the powder over a smaller region of the central portion 112 (FIG. 1A) for a build object that gets narrow near the top (e.g., to reduce the amount of unused powder surrounding the build object while providing sufficient support for the upper layers). Additionally, or alternatively, the controller 170 can control the operational parameters to respond to various other detected events in the build chamber 110 of FIG. 1A. For example, the build chamber 110 can include sensors positioned to detect a shortfill in a most recent layer, and the controller 170 can take steps to rectify the shortfill before sintering the most recent layer. In a specific, non-limiting example, the controller 170 can update the operational parameters to cause the powder deposition system 140 to deposit a volume of the spreadable powder 108 that is sufficient to rectify the shortfill (e.g., fill in the remaining layer) and cause the recoater arm 130 to make another pass along the second motion path B of FIG. 1A before sintering the most recent layer. In some embodiments, the recoater arm 130 pauses when a shortfill is detected and the additional powder is deposited before the recoater arm 130 continues moving. In some embodiments, the recoater arm 130 returns to a starting position (e.g., in the peripheral portion 114 of FIG. 1A) before the additional powder is deposited. Once the shortfill is rectified, the controller 170 (FIG. 1A) can update the operational parameters again to return to a baseline for the build process (or an adjusted baseline to avoid further shortfills).

In some embodiments, the edge portions 136 are integrally formed with the housing 131 (e.g., formed from a continuous volume of material). The integral construction avoids joints and can help ensure that the powder 106 cannot pass through the opening 134 except via the orifice component 142 in the manner described above. In some embodiments, the edge portions 136 are initially separate from the housing 131 and/or made from a different material. The different material can allow the edge portions to be customized for different builds. For example, a first set of the edge portions 136 that define a relatively small perimeter for the opening 134 can be installed for a build process with a relatively small build object (e.g., therefore requiring less of the spreadable powder 108 per layer), and a second set of the edge portions 136 defining a larger perimeter can be installed for a build process with a relatively large build object. In some embodiments, the edge portions 136 are omitted altogether. For example, the orifice component 142 can span across the opening 134 entirely and thereby eliminate the need for edge portions to restrict the flow of the powder 108 through the opening 134. In various embodiments, the orifice component 142 can extend across a portion of the central portion 112 of FIG. 1A (e.g., have a length along the y-axis that is less than a width of the central portion 112 along the y-axis), extend fully across the central portion 112, and/or extend beyond the central portion 112.

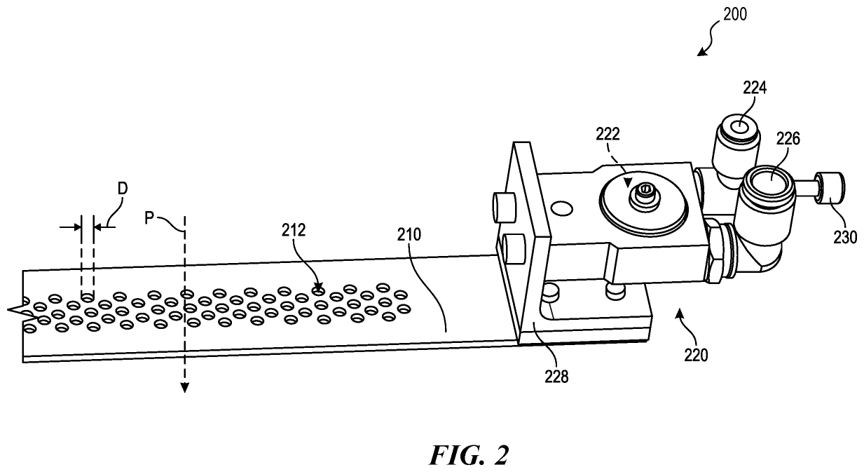

FIG. 2 is an isometric view of a portion of a powder deposition system 200 configured in accordance with some embodiments of the present technology. Similar to the powder deposition system 140 discussed above with reference to FIG. 1B, the powder deposition system 200 includes a at least one orifice component 210 (one shown in the illustrated embodiment) and a vibrational component 220 operably coupled to the at least one orifice component 210. Further, the at least one orifice component 210 (“orifice component 210”) includes a plurality of openings 212 (sometimes also referred to as “holes,” “passages,” and the like). Each of the openings 212 has a diameter D that is sized to restrict (and/or prevent) powder from flowing along flow path P through the orifice component 210 until the orifice component 210 is vibrated.

In the illustrated embodiment, the vibrational component 220 includes an eccentric cam 222 that is operably coupled to a supply line 224, a return line 226, a coupling member 228, and an adjustment mechanism 230. The eccentric cam 222 is a disc with an off-center center of rotation. In the illustrated embodiment, the rotation of the eccentric cam 222 is driven by an inert gas (e.g., argon gas) and/or any other suitable fluid. The inert gas can be controllably delivered from a storage (or other suitable supply) via the supply line 224 and returned to the storage (or other suitable exhaust) via the return line 226. In a specific, non-limiting example, the supply line 224 can be coupled, through one or more control valves and/or suitable pumps, to a cryogenic tank of liquid argon that provides pressurized argon gas that has boiled out of the liquid argon. In various embodiments, the pressure, speed, volume, temperature, and the like of the inert gas can be controlled (e.g., by a pump under the control of the controller 170 of FIG. 1A), each of which can affect the speed and/or torque of the rotation of the eccentric cam 222.

In various other embodiments, the eccentric cam 222 is driven through various other mechanisms. For example, the center of rotation for the eccentric cam 222 can be coupled to an electric motor, thereby allowing the speed, torque, etc. to be varied by controlling operation of the electric motor. Still further, the eccentric cam 222 can be replaced by various other mechanisms to drive movement (e.g., vibration, oscillation, and/or the like) in the vibrational component 220. Purely by way of example, the vibrational component 220 can include a piezoelectric device, a compression diver, a piston, and/or any other suitable mechanism to controllably move the orifice component 210 back and forth.

In the embodiment illustrated in FIG. 2, the coupling member 228 is operatively coupled between the eccentric cam 222 and the orifice component 210. As a result, for example, rotating the eccentric cam 222 vibrates the coupling member 228, which in turn vibrates the orifice component 210. In some embodiments, for example, the coupling member includes a flat follower coupled to the eccentric cam 222 such that the first half of a rotation moves the coupling member 228 and the orifice component 210 to the left (in the illustrated orientation), while the second half of the rotation moves the coupling member 228 and the orifice component 210 to the right. As discussed above, the movement causes powder above the orifice component 210 to move through the openings 212 along the flow path P.

The adjustment mechanism 230 can be coupled to the eccentric cam 222 and/or the supply line 224 to help control various operating parameters of the eccentric cam 222. In various embodiments, for example, the adjustment mechanism 230 can be coupled to a resistance mechanism in the eccentric cam 222 to alter the amount of rotation that a given volume and/or pressure of the inert gas will cause, a valve on the supply line 224 to adjust the volume of the inert gas that is delivered, the eccentric cam 222 to adjust the center of rotation (and thereby adjust the eccentricity of the cam and the amplitude of the vibrations), and/or any other suitable aspect of the vibrational component 220. In some embodiments, the adjustment mechanism 230 is operably coupled to the controller 170 (FIG. 1A), allowing the controller to adjust the operation of the powder deposition system 200 as necessary during a build process.

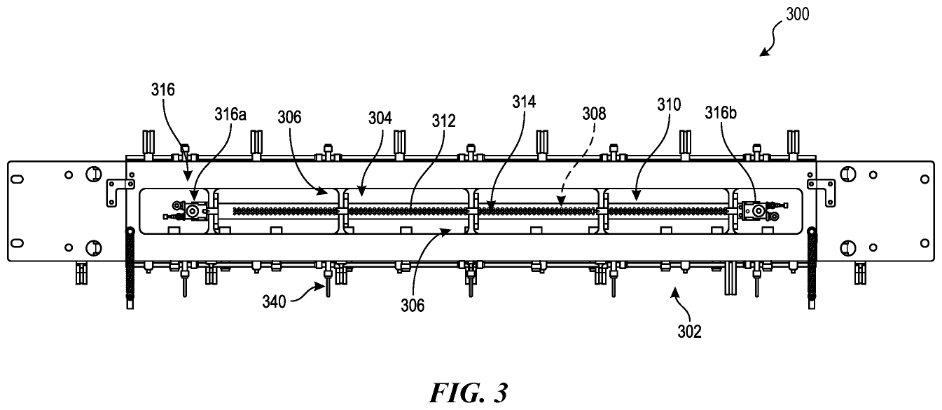

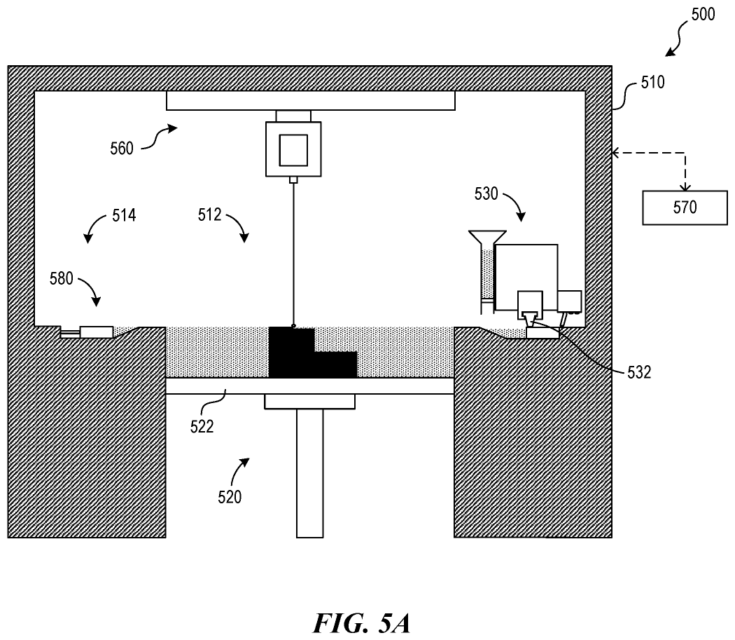

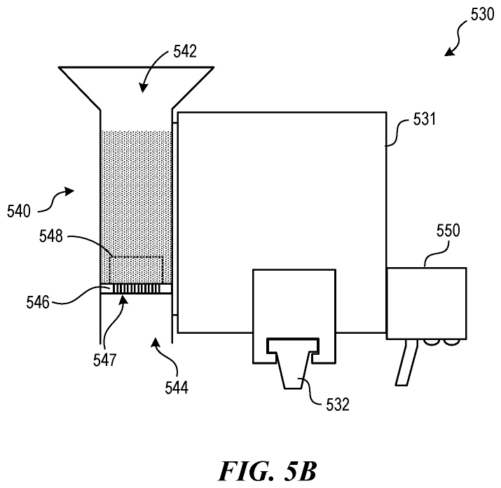

FIG. 3 is a top view of a recoater arm 300 configured in accordance with some embodiments of the present technology. In the illustrated embodiment, the recoater arm 300 includes a housing 302 that has an opening 304 to store powder and/or provide a path to deposit the powder during a build process. The housing also includes edge portions 306 that define a perimeter around a slot 308 in the opening 304. The slot 308 can be positioned to direct any powder deposited into the opening 304 to an appropriate position during the build process. For a two-blade recoater arm, for example, the slot 308 can be positioned to direct the powder between the blades. For a single blade recoater arm, in another example, the slot 308 can be positioned to direct the powder in front of the recoater arm (e.g., as discussed in more detail with reference to FIGS. 5A and 5B below).

As further illustrated in FIG. 3, the recoater arm 300 also includes a powder deposition system 310 positioned to control the movement of the powder through the opening 304. Similar to the powder deposition systems discussed above, the powder deposition system 310 includes at least one orifice component 312 positioned over the slot 308 (one shown in the illustrated embodiment), and one or more vibrational components 316 (two shown in the illustrated embodiment). The at least one orifice component 312 (“orifice component 312”) includes a plurality of openings that are sized to restrict the movement of powder through the orifice component. The vibrational components 316 (referred to individually as first and second vibrational components 316a, 316b) can each be controlled to cause the orifice component 312 to vibrate at appropriate times to deposit a controlled volume of spreadable powder during the build process. Including multiple vibrational components 316 can help ensure that the entirety of the orifice component 312 is vibrated during operation of the powder deposition system 310. For example, the orifice component 312 may absorb some of the vibrational input from the vibrational components 316 over distance (e.g., such that a point far away from one of the vibrational components 316 does not move as much as a point close to one of the vibrational components 316). By applying a vibrational input at multiple points, the vibrational components 316 can help ensure that no points are far enough from one of the vibrational components 316 to not move (or not move enough to cause powder to move through the openings 314).

In some embodiments, the first and second vibrational components 316a, 316b are synchronized to move the orifice component 312 left and right (in the illustrated orientation) at the same time. In some embodiments, the first and second vibrational components 316a, 316b are not synced, which can result in more complex vibrations. Further, in some embodiments, only one of the vibrational components 316 is operated at a time. For example, when a shortfill is detected on the left side of the active build region 115 (FIG. 1A), the first vibrational component 316a can be operated to vibrate the orifice component 312 while the second vibrational component 316b is not. As a result (and as a result of dampening vibration through the orifice component 312), more powder is deposited on the left side. The recoater arm 300 can then make another pass over the active build region 115 (e.g., along the second motion path of FIG. 1A) to spread the powder. The targeted deposition can help avoid a build-up of excess powder on the right side while correcting the shortfill on the left side.

As further illustrated in FIG. 3, the recoater arm can include one or more powder wave sensors 340. The powder wave is a of the powder that is being pushed by the recoater arm 300 while spreading the powder over the active build region 115 (FIG. 1A). Additional details regarding the powder wave are disclosed in co-filed U.S. Application No. [Attorney Docket No. 034563.8052.US00]_, incorporated by reference above. The powder wave sensors can monitor the powder being spread by the recoater arm 300 during the active build process and relay signals to the controller 170 (FIG. 1A). As a result, the powder wave sensors 340 can help the controller 170 monitor for shortfills, insufficient volumes of powder, excess powder, and/or excess build-ups, each of which can cause errors in the build process. In various embodiments, the powder wave sensors 340 can include optical sensors, presence sensors, mechanical sensors, and/or any other suitable sensor. In a specific, non-limiting example, the powder wave sensors 340 can be similar to those described in co-filed U.S. Patent Application No. [Attorney Docket No. 034563.8052.US00]_, incorporated by reference above.

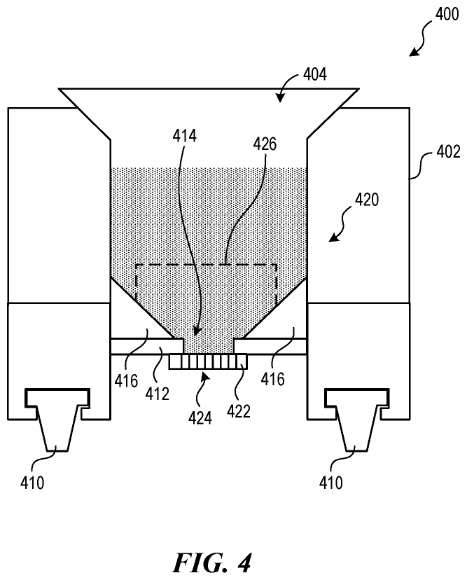

FIG. 4 is a partially schematic side view of a recoater arm 400 configured in accordance with further embodiments of the present technology. In the illustrated embodiment, the recoater arm 400 is generally similar to the recoater arm 130 described above with reference to FIG. 1B. For example, the recoater arm 400 includes a housing 402 with an opening 404 for receiving powder and/or providing a travel path for the powder during a build process. The recoater arm 400 also includes one or more blades 410 (two shown in the illustrated embodiment) carried by the housing 402, edge portions 412 defining a perimeter of a slot 414 in the opening 404, and a powder deposition system 420 positioned in the opening 404. Further, the powder deposition component includes at least one orifice component 422 (one shown in the illustrated embodiment) and a vibrational component 426. The at least one orifice component 422 (“orifice component 422”) includes a plurality of openings 424 and is positioned to reduce (or prevent) movement of powder through the slot 414 until the vibrational component 426 is operated.

In the illustrated embodiment, however, the recoater arm 400 also includes sloped components 416 (or “sloped portions”) above the edge portions 412 in the opening 404. The sloped components 416 can help direct the powder toward the slot 414, thereby avoiding a build-up of unused powder above the edge portions 412. Further, in the illustrated embodiment, the orifice component 422 is positioned beneath the edge portions 412. In various embodiments, however, the orifice component 422 can be positioned above the edge portions 412 with the sloped components 416 sloping toward the openings 424 therein, and/or the edge portions 412 can be omitted with the orifice component 422 and the sloped components 416 spanning the entire opening 404.

FIG. 5A is a partially schematic, partially cross-sectional view of an additive manufacturing system 500 configured in accordance with further embodiments of the present technology. As illustrated in FIG. 5A, the additive manufacturing system 500 (“system 500”) is generally similar to the system 100 described above with reference to FIG. 1A. For example, the system 500 includes a build chamber 510 that has a central portion 512 and a peripheral portion 514. The system 500 also includes a support system 520 with a movable support plate 522, a recoater arm 530, an energy beam system 560 each positioned within the build chamber 510, as well as a controller 570 operably coupled to various components of the system 500.

In the embodiment shown in FIG. 5A, however, the recoater arm 530 includes a single blade 532. Further, the system 500 includes a powder recycling system 580 that enables the recoater arm 530 to function with only a single blade and without a waste disposal system. More specifically, the powder recycling system 580 includes components positioned in the peripheral portion 514 of the build chamber 510 that push powder back toward the central portion 512 after each trip of the recoater arm 530 along the second motion path B. Additional details on a suitable powder recycling system are disclosed in co-filed U.S. Patent Application No. [Attorney Docket No. 034563.8052. US00], incorporated by reference above.

FIG. 5B is a partially schematic side view of a recoater arm 530 of the type illustrated in FIG. 5A in accordance with further embodiments of the present technology. As illustrated, the recoater arm 530 includes a housing 531 that carries various components of the recoater arm 530. For example, in the illustrated embodiment, the blade 532 is carried by a lower surface of the housing 531, a powder deposition system 540 is carried by a first sidewall of the housing 531, and a powder wave sensor 550 is carried by a second sidewall of the housing 531 opposite the powder deposition system 540. In the illustrated configuration, the powder deposition system 540 is positioned to deposit a powder in front of the blade 532 (e.g., in a spreadable location) before a first trip or pass over the central portion 512 (e.g., from right to left in FIG. 5A), and the powder wave sensor 550 is positioned to measure powder being pushed by the blade 532 during a second trip over the central portion 512 (e.g., from left to right in FIG. 5A). However, it will be understood that the powder deposition system 540 and/or the powder wave sensor 550 can be carried by the housing 531 in various other suitable positions. For example, the recoater arm 530 can include an opening on the inside of the housing 531 (but forward from the blade 532 when moving from right to left), and the powder deposition system 540 can be positioned in the opening. In this position, the powder deposition system 540 can be integrated with the housing 531, instead of, for example, requiring a separate chamber to store powder during the build process.

In the illustrated embodiment, the powder deposition system 540 is generally similar to the powder deposition systems discussed above (e.g., with reference to FIG. 1B). For example, the powder deposition system includes a tank 542 with a chamber 544, at least one orifice component 546 positioned in communication with the chamber 544, and a vibrational component 548 operably coupled to the at least one orifice component 546. The at least one orifice component 546 (“orifice component 546”) includes a plurality of passages 547. When not in motion, the plurality of passages 547 inhibit (and/or obstruct and/or impede) the powder from moving through the tank 542. Activating the vibrational component 548 vibrates the orifice component 546, thereby causing powder to flow through the plurality of passages 547 and out of the tank 542. Further, the orifice component 546 is positioned such that an individual powder element (e.g., a single particle of powder) only flows through a single one of the passages 547 in a single orifice component 546 to move from the tank 542 to a spreadable position in front of the blade 532 (e.g., when being deposited).

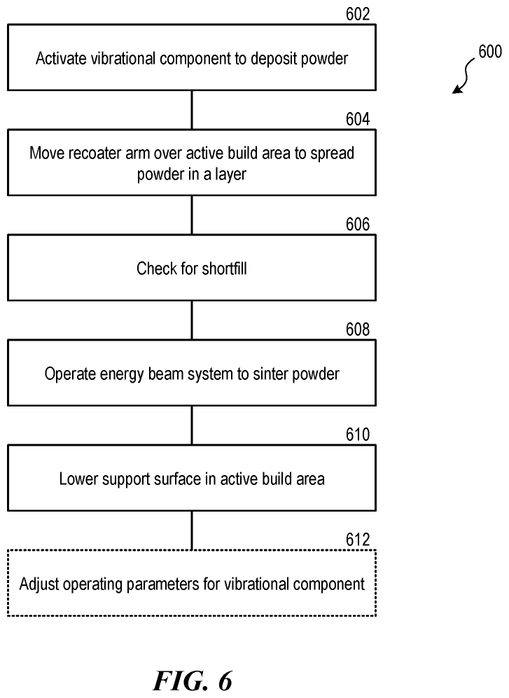

FIG. 6 is a flow diagram of a process 600 for operating an additive manufacturing system in accordance with further embodiments of the present technology. The process 600 can be implemented by the controller 170 of FIG. 1A to control various components of the system 100. It will be understood that the process 600 can be repeated any suitable number of times during a relevant build process to construct ab build object.

The process 600 begins at block 602 with activating the vibrational component(s) (e.g., the vibrational component 220 of FIG. 2). As discussed above, activating the vibrational component(s) causes the orifice component(s) to vibrate and deposit the powder in a controllable. The operation of the vibrational component(s) can be based on one or more operating parameters that are set before the build process and/or adjusted during the build process. For example, the operational parameters can include the amount of time the vibrational component(s) are operated, the frequency of the vibrations and/or oscillations, the speed of the vibrational component(s), the magnitude of the vibrations and/or oscillations, and/or the like. Each of the operating parameters can impact the volume of the powder that is deposited and/or the distribution of the powder that is deposited (e.g., along a longitudinal axis of the orifice component). Additionally, or alternatively, one or more of the operating parameters can be set and/or adjusted to break up impurities in the powder being deposited (e.g., clods of the powder).

At block 604, the process 600 includes moving the recoater arm over the active build region to spread the powder deposited at block 602 into a new layer. As the recoater arm moves, the blade(s) spread the powder deposited at block 602 into an even (or generally even) new layer over the support platform, the portion of the build object already completed, and/or the previous layer of powder. In some embodiments, block 604 includes moving the recoater arm forward and backward over the active build region (e.g., forward from right to left along the second motion path B illustrated in FIG. 1A, then backward from left to right along the second motion path B). In some embodiments, block 604 includes multiple forward and backward trips over the active build region. In some embodiments, block 604 includes only a single trip over the active build region (e.g., forward from right to left along the second motion path B illustrated in FIG. 1A).

At block 606, the process 600 includes checking for a shortfill in the new layer. A shortfill refers to an insufficient volume of powder deposited at block 602 (e.g., insufficient to spread into an even (or generally even) layer at block 604). As a result, the new layer includes gaps and/or regions with a non-uniform (or generally non-uniform) thickness. If unaddressed, the shortfill can cause errors in the process 600. For example, the gaps and/or non-uniform regions of the layer can translate to gaps and/or other errors in the build object. In various embodiments, the detecting deficiencies at block 606 can be based on signals from a sensor onboard the recoater arm and/or various other sensors in the build chamber (e.g., one or more optical sensors positioned in the build chamber 110 of FIG. 1A and directed at the active build region 115).

When the process 600 detects a deficiency, the process 600 can return to blocks 602 and 604 to deposit and spread an additional volume of powder to rectify the shortfill. As discussed above, rectifying the shortfill can include modifying the operating parameters to deposit (then spread) a smaller volume of the powder than is deposited for a new layer. In some embodiments, the modification can be based on the magnitude of the shortfill (e.g., based on whether the shortfill is detected for a quarter of the new layer, half of the new layer, or some other portion of the new layer), the location of the detected shortfill, and/or any other suitable information. After rectifying the shortfill, or when no shortfill is detected, the process 600 continues to block 608.

At block 608, the process 600 includes operating the energy beam system (e.g., the energy beam system 160 of FIG. 1A) to sinter powder in the new layer. More specifically, the energy beam system can direct one or more energy beams (e.g., laser beams) toward specific portions of the new layer to sinter (e.g., joining, partially melting, welding, and/or the like) the targeted portions to each other and/or to previous layers in the build object. As discussed above, sintering the targeted portions of the new layer can include moving one or more energy beam directors along a track in the build chamber and/or operating one or more servo mirrors to direct the energy beam(s).

At block 610, the process 600 includes lowering a support surface (e.g., lowering the support platform 122 of FIG. 1A). By lowering the support surface, the process 600 provides room for the next layer of powder to be spread over the active build region (e.g., covering the previous new layer and the portions of the build object resulting from block 608) without needing to raise the recoater arm. Further, by lowering the support surface to maintain each new layer at the same (or generally the same) elevation during block 608, the process 600 can repeat blocks 602-608 without needing to adjust the energy beam system for a changing depth of the target.

At optional block 612, the process 600 includes adjusting the operating parameters for the vibrational component(s). The adjustments at optional block 612 can return the operating parameters to a baseline after rectifying a shortfill, increase a baseline after a detected shortfill, account for a near-shortfill, account for a detected overfill, allow the process 600 to adapt based on a plan for the build object (e.g., to deposit less powder near the top of a tapering build object), and/or the like. After adjusting the operating parameters at optional block 612 (or without adjusting the operating parameters), the process 600 can return to block 602 for the next layer of the build object.

### EXAMPLES

The present technology is illustrated, for example, according to various aspects described below. Various examples of aspects of the present technology are described as numbered examples (1, 2, 3, etc.) for convenience. These are provided as examples and do not limit the present technology. It is noted that any of the dependent examples can be combined in any suitable manner, and placed into a respective independent example. The other examples can be presented in a similar manner.

1. A powder deposition system positionable in a powder dispensing channel of an additive manufacturing system, the powder deposition system comprising:
at least one orifice member positioned at least proximate to an end of the powder dispensing channel such that an individual powder element passes through only a single orifice member to be deposited, wherein:
   the at least one orifice member includes one or more perforations, and
   the at least one orifice member has a first mode in which no powder or a first amount of powder passes through the one or more perforations and a second mode in which a second amount of powder passes through the one or more perforations, wherein the second amount is non-zero and greater than the first amount; and
a vibrational component operably coupled to the at least one orifice member, wherein operation of the vibrational component causes the at least one orifice member to vibrate and enter the second mode to allow the second amount of powder to flow through the one or more perforations.

2. The powder deposition system of example 1 wherein the least one orifice member positioned is positioned beneath a powder storage component.

3. The powder deposition system of any of examples 1 and 2 wherein in the vibrational component is a first vibrational component operably coupled to a first end region of the at least one orifice member, and wherein the powder deposition component further comprises a second vibrational component operably coupled to a second end region of the at least one orifice member.

4. The powder deposition system of any of examples 1-3 wherein the vibrational component comprises an eccentric cam drivable via movement of a fluid through the eccentric cam and wherein the vibrational component is operably couplable to a fluid source.

5. The powder deposition system of example 4 wherein the fluid source comprises an argon gas source.

6. The powder deposition system of any of examples 1-5 wherein the one or more perforations are further sized to prevent impurities in the powder from flowing through the at least one orifice member.

7. The powder deposition system of any of examples 1-6, further comprising a controller operably coupled to the vibrational component, the controller storing instructions that, when executed by the controller, cause the controller to operate the vibrational component at a predetermined speed for a predetermined time and/or a selected location to control the volume of the powder flowing through the one or more perforations based on a target volume for at least one individual layer during a build process.

8. An additive manufacturing system, comprising:
a build chamber having an active build region;
a support platform positioned in the active build region and movable in a travel direction having upward and downward components; and
a recoater arm positioned in the build chamber and movable in a first lateral direction above the active build region to spread a powder over the active build region during a build process, wherein the recoater arm comprises:
   a first blade extending in a second lateral direction;
   a second blade spaced apart from the first blade;
   at least one orifice member positioned such that an individual powder element passes through only a single orifice member to be deposited between the first and second blades, wherein the single orifice member includes a plurality of openings sized to at least partially inhibit a flow of the powder through the at least one orifice member while the at least one orifice member is stationary; and
   a vibrational component operably coupled to the at least one orifice member to vibrate the at least one orifice member to establish a pathway for the powder through the at least one orifice member; and
a controller operably coupled to the vibrational component, the controller having instructions that, when executed by the controller, cause the controller to operate the vibrational component to dispense a volume of the powder.

9. The additive manufacturing system of example 8 wherein the volume of the powder dispensed is proportional to a speed of the vibrational component during operation.

10. The additive manufacturing system of any of examples 8 and 9 wherein the recoater arm further comprises a powder storage component operably coupled to the recoater arm upstream from the at least one orifice member.

11. The additive manufacturing system of any of examples 8-10 wherein the recoater arm further comprises a powder storage component positioned upstream from the at least one orifice member.

12. The additive manufacturing system of any of examples 8-11 wherein the instructions cause the controller to dispense the volume of the powder based on a target volume for an individual layer during the build process.

13. The additive manufacturing system of example 12 wherein the instructions cause the controller to operate the vibrational component at a target speed for a target time to control the volume of the powder dispensed based on the target volume.

14 The additive manufacturing system of example 13, wherein the instructions further cause the controller to:
receive, after depositing a first layer during the build process, an update to the target volume; and
prior to depositing a second layer during the build process, adjust the target speed and/or the target time to account for the update to the target volume.

15. The additive manufacturing system of any of examples 8-14 wherein the vibrational component comprises an eccentric cam drivable via movement of a fluid that is operably coupled to the eccentric cam.

16. The additive manufacturing system of any of examples 8-15 wherein the at least one orifice member extends in a third lateral direction generally parallel to the second lateral direction for a distance at least equal to a width of the active build region along the third lateral direction.

17. A recoater arm for use in an additive manufacturing system, the recoater arm comprising:
at least one blade extending in a lateral direction;
a powder dispensing channel positioned proximate to the at least one blade and operably coupleable to a storage component to direct a powder to a spreadable location during operation of the additive manufacturing system; and
a powder deposition system positioned at least proximate to an end of the powder dispensing channel, the powder deposition system comprising:
   at least one orifice member positioned at least proximate to an end of the powder dispensing channel such that an individual powder element passes through only a single orifice member to be deposited, wherein the at least one orifice member includes one or more perforations, wherein the at least one orifice member has a first mode in which no powder or a first amount of powder passes through the one or more perforations and a second mode in which a second amount of powder passes through the one or more perforations, and wherein the second amount is non-zero and greater than the first amount; and
   a vibrational component operably coupled to the at least one orifice member, wherein operation of the vibrational component causes the at least one orifice member to vibrate and allow a volume of the powder to flow through the one or more perforations.

18. The recoater arm of example 17 wherein the powder dispensing channel and the storage component are positioned above the at least one orifice member.

19. The recoater arm of any of examples 17 and 18 wherein in the vibrational component is a first vibrational component operably coupled to a first end region of the at least one orifice member, and wherein the recoater arm further comprises a second vibrational component operably coupled to a second end region of the at least one orifice member.

20. The recoater arm of any of examples 17-19 wherein the vibrational component comprises an eccentric cam drivable via movement of a fluid through the eccentric cam and wherein the vibrational component is operably couplable to a fluid source.

21 The recoater arm of example 20 wherein the fluid source comprises an argon gas source.

22. The recoater arm of any of examples 17-21 wherein the one or more perforations are further sized to prevent impurities in the powder from flowing through the at least one orifice member.

23. The recoater arm of any of examples 17-22, further comprising a controller operably coupled to the vibrational component, the controller storing instructions that, when executed by the controller, cause the controller to operate the vibrational component at a predetermined speed for a predetermined time and/or a selected location to control the volume of the powder flowing through the one or more perforations based on a target volume for at least one individual layer during a build process.

24. A method for operating an additive manufacturing system, the method comprising:
operating an oscillating component operably coupled to at least one orifice member, wherein movement of the at least one orifice member in response to operation of the oscillating component causes a volume of a powder to move through one or more openings in the at least one orifice member to a dispensing area adjacent to a recoater arm;
moving the recoater arm forward and backward over a build area within a build chamber of the additive manufacturing system to spread the volume of the powder into a layer over the build area;
operating an energy beam component to sinter at least a portion of the volume of the powder to a structure in the build area beneath the layer; and
actuating a support surface to lower the layer and the structure to create a space for a new layer to be spread over the build area.

25. The method of example 24 wherein the oscillating component is operated based on operating parameters comprising a predetermined period of operation and a predetermined speed, wherein the volume of the powder deposited is proportional to the predetermined period and the predetermined speed.

26 The method of example 25, further comprising adjusting the operating parameters after moving the recoater arm forward and backward over the build area to adjust a characteristic with which the powder is deposited.

27. The method of example 26, further comprising detecting a build-up of excess powder, wherein adjusting the operating parameters is based on the detected build-up of excess powder.

28 The method of any of examples 24-27 wherein the volume is a first volume, and wherein the method further comprises:
detecting a shortfill in the layer, the shortfill corresponding to a powder distribution less than a powder distribution target; and
operating the oscillating component to cause a second volume of a powder to move through the one or more openings in the at least one orifice member to the dispensing area correct the detected shortfill.

### CONCLUSION

From the foregoing, it will be appreciated that specific embodiments of the technology have been described herein for purposes of illustration, but well-known structures and functions have not been shown or described in detail to avoid unnecessarily obscuring the description of the embodiments of the technology. To the extent any material incorporated herein by reference conflicts with the present disclosure, the present disclosure controls. Where the context permits, singular or plural terms may also include the plural or singular term, respectively. Furthermore, as used herein, the phrase “and/or” as in “A and/or B” refers to A alone, B alone, and both A and B. Additionally, the terms “comprising,” “including,” “having,” and “with” are used throughout to mean including at least the recited feature(s) such that any greater number of the same features and/or additional types of other features are not precluded. Further, the terms “approximately” and “about” are used herein to mean within at least within 10 percent of a given value or limit. For example, an approximate ratio means within a ten percent of the given ratio.

From the foregoing, it will also be appreciated that various modifications may be made without deviating from the disclosure or the technology. For example, although discussed herein primarily in the context of laser beams, one of skill in the art will appreciate that various other energy beams can be used to sinter the powder in each layer of the build object. Furthermore, the energy beam(s) can be used to perform various other functions in the system (e.g., to remove material from layers of the build object rather than sintering powder for new layers of the build object). In another example, the eccentric cam can be replaced by another suitable vibrational component, such as a piezoelectric component, a compression driver, crankshaft, piston, and/or the like. In various other examples, various components of the system can have shapes other than those illustrated herein. For example, the openings in the orifice component can be square, triangular, hexagonal, and/or any other shape. In another example, the orifice component can have a tapered upper and/or lower surface. Additionally, or alternatively, one of ordinary skill in the art will understand that various components of the technology can be further divided into subcomponents, or that various components and functions of the technology may be combined and integrated. For example, although illustrated primarily in the context of a system with a single orifice component, the system can include multiple orifice components in a single layer and/or in non-overlapping layers. In a specific, non-limiting example, the system could include a first orifice component that extends across (or generally across) a first half of the recoater arm and a second orifice component that extends across (or generally across) a second half of the recoater arm. In addition, certain aspects of the technology described in the context of particular embodiments may also be combined or eliminated in other embodiments. For example, the controller can be split into multiple controllers each operably coupled to one or more components of the system to perform the actions described herein. In a specific, non-limiting example, the recoater arm can include an individual controller that controls the components of the powder deposition system (e.g., the vibrating components) and/or the movement of the recoater arm.

Furthermore, although advantages associated with certain embodiments of the technology have been described in the context of those embodiments, other embodiments may also exhibit such advantages, and not all embodiments need necessarily exhibit such advantages to fall within the scope of the technology. Accordingly, the disclosure and associated technology can encompass other embodiments not expressly shown or described herein.

We claim:

1. A powder deposition system positionable in a powder dispensing channel of an additive manufacturing system, the powder deposition system comprising:
at least one orifice component positioned at least proximate to an end of the powder dispensing channel such that an individual powder element passes through only a single orifice component to be deposited, wherein:
the at least one orifice component includes one or more perforations, and
the at least one orifice component has a first mode in which no powder or a first amount of powder passes through the one or more perforations and a second mode in which a second amount of powder passes through the one or more perforations, wherein the second amount is non-zero and greater than the first amount; and
a vibrational component operably coupled to the at least one orifice component, wherein operation of the vibrational component causes the at least one orifice component to vibrate and enter the second mode to allow the second amount of powder to flow through the one or more perforations.

2. The powder deposition system of claim 1 wherein the least one orifice component is positioned beneath a powder storage component.

3. The powder deposition system of claim 1 wherein the vibrational component is a first vibrational component operably coupled to a first end region of the at least one orifice component, and wherein the powder deposition component further comprises a second vibrational component operably coupled to a second end region of the at least one orifice component.

4. The powder deposition system of claim 1 wherein the vibrational component comprises an eccentric cam drivable via movement of a fluid through the eccentric cam and wherein the vibrational component is operably couplable to a fluid source.

5. The powder deposition system of claim 4 wherein the fluid source comprises an argon gas source.

6. The powder deposition system of claim 1 wherein the one or more perforations are further sized to prevent impurities in the powder from flowing through the at least one orifice component.

7. The powder deposition system of claim 1, further comprising a controller operably coupled to the vibrational component, the controller storing instructions that, when executed by the controller, cause the controller to operate the vibrational component at a predetermined speed for a predetermined time and/or at a selected location to control a volume of the powder flowing through the one or more perforations based on a target volume for at least one individual layer during a build process.

8. An additive manufacturing system, comprising:
a build chamber having an active build region;
a support platform positioned in the active build region and movable in a travel direction having upward and downward components; and
a recoater arm positioned in the build chamber and movable in a first lateral direction above the active build region to spread a powder over the active build region during a build process, wherein the recoater arm comprises:
a first blade extending in a second lateral direction;
a second blade spaced apart from the first blade;
at least one orifice component positioned such that an individual powder element passes through only a single orifice component to be deposited between the first and second blades, wherein the single orifice component includes a plurality of openings sized to at least partially inhibit a flow of the powder through the at least one orifice component while the at least one orifice component is stationary; and
a vibrational component operably coupled to the at least one orifice component to vibrate the at least one orifice component to establish a pathway for the powder through the at least one orifice component; and
a controller operably coupled to the vibrational component, the controller having instructions that, when executed by the controller, cause the controller to operate the vibrational component to dispense a volume of the powder.

9. The additive manufacturing system of claim 8 wherein the volume of the powder dispensed is proportional to a speed of the vibrational component during operation.

10. The additive manufacturing system of claim 8 wherein the recoater arm further comprises a powder storage component operably coupled to the recoater arm upstream from the at least one orifice component.

11. The additive manufacturing system of claim 8 wherein the recoater arm further comprises a powder storage component positioned upstream from the at least one orifice component.

12. The additive manufacturing system of claim 8 wherein the instructions cause the controller to dispense the volume of the powder based on a target volume for an individual layer during the build process.

13. The additive manufacturing system of claim 12 wherein the instructions cause the controller to operate the vibrational component at a target speed for a target time to control the volume of the powder dispensed based on the target volume, and wherein the instructions further cause the controller to:
receive, after depositing a first layer during the build process, an update to the target volume; and
prior to depositing a second layer during the build process, adjust the target speed and/or the target time to account for the update to the target volume.

14. The additive manufacturing system of claim 8 wherein the vibrational component comprises an eccentric cam drivable via movement of a fluid that is operably coupled to the eccentric cam.

15. A method for operating an additive manufacturing system, the method comprising:
operating an oscillating component operably coupled to at least one orifice component, wherein movement of the at least one orifice component in response to operation of the oscillating component causes a volume of a powder to move through one or more openings in the at least one orifice component to a dispensing area adjacent to a recoater arm;
moving the recoater arm forward and backward over a build area within a build chamber of the additive manufacturing system to spread the volume of the powder into a layer over the build area;
operating an energy beam component to sinter at least a portion of the volume of the powder to a structure in the build area beneath the layer; and
actuating a support surface to lower the layer and the structure to create a space for a new layer to be spread over the build area.

16. The method of claim 15 wherein the oscillating component is operated based on operating parameters comprising a predetermined period of operation and a predetermined speed, wherein the volume of the powder deposited is proportional to the predetermined period and the predetermined speed.

17. The method of claim 16, further comprising adjusting the operating parameters after moving the recoater arm forward and backward over the build area to adjust a characteristic with which the powder is deposited.

18. The method of claim 17, further comprising detecting a build-up of excess powder, wherein adjusting the operating parameters is based on the detected build-up of excess powder.

19. The method of claim 15 wherein the volume is a first volume, and wherein the method further comprises:
detecting a shortfill in the layer, the shortfill corresponding to a powder distribution less than a powder distribution target; and
operating the oscillating component to cause a second volume of a powder to move through the one or more openings in the at least one orifice component to the dispensing area correct the detected shortfill.

20. The method of claim 15 wherein the oscillating component is operated based on operating parameters that are based at least partially on characteristics of the powder above the orifice component.
